(19) United States
(12) Patent Application Publication
(10) Pub. No.: US 2012/0301249 A1
(43) Pub. Date: Nov. 29, 2012

(54) FASTENER IDENTIFICATION MARKING

(75) Inventors: David W. Jablonski, Wheaton, IL (US); John Jason Roxburgh, Chicago, IL (US); William M. Heflin, Paris, KY (US)

(73) Assignee: ILLINOIS TOOL WORKS INC., Glenview, IL (US)

(21) Appl. No.: 13/114,926

(22) Filed: May 24, 2011

(51) Int. Cl. F16B 15/00; F16B 35/00

(52) U.S. Cl. 411/394; 411/439

(57) ABSTRACT

A fastener for being inserted a first depth d₁ through a first object and a second depth d₂ into or through a second object, is provided. The fastener includes, but is not limited to, a head having an outer surface opposed to an inner surface, a shank connected with the inner surface of the head at a first end and forming a tip at a second end opposed to the first end, and an identification marking formed on the outer surface. The outer surface remains exposed upon the fastener being inserted into an object. The shank has an actual length Lₐ from the first end to the second end, and wherein the actual length Lₐ is equal to or greater than the sum of the first depth d₁ and the second depth d₂. The identification marking indicates an embedment depth dₑ of the fastener.

### BACKGROUND OF THE INVENTION

Certain applications require use of a power driven fastener to attach a first object, such as a metal bracket, to a second object, such as a concrete wall. After a fastener is embedded through the first object and into or through the second object, by an installer, an interested third party such as a contractor or a building inspector, does not know the actual length or the embedment depth of the fastener into the second object. Being that a power driven fastener is intended to be a permanent fastening, the embedded fastener may need to be removed, possibly causing damage to the first object, the second object, or the fastener itself, in order to verify the actual length or the embedment depth of the fastener.

It would therefore be desirable to allow interested parties to determine the actual length or the embedment depth of a power driven fastener after installation without having to remove the fastener, and possibly causing damage to the first object, the second object, or the fastener itself.

### SUMMARY

The present invention is defined by the following claims, and nothing in this section should be taken as a limitation on those claims.

In one aspect, a fastener for being inserted a first depth d₁ through a first object and a second depth d₂ into or through a second object, is provided. The fastener includes, but is not limited to, a head having an outer surface opposed to an inner surface, a shank connected with the inner surface of the head at a first end and forming a tip at a second end opposed to the first end, and an identification marking formed on the outer surface. The outer surface remains exposed upon the fastener being inserted into an object. The shank has an actual length Lₐ from the first end to the second end, and wherein the actual length Lₐ is equal to or greater than the sum of the first depth d₁ and the second depth d₂. The identification marking indicates an embedment depth dₑ of the fastener.

In one aspect, a fastener is provided. The fastener includes, but is not limited to, a head having an outer surface, a shank connected with the head at a first end and forming a tip at a second end opposed to the first end, and an identification marking formed on the outer surface. The outer surface remains exposed upon the fastener being inserted into an object. The shank has an actual length Lₐ from the first end to the second end. The identification marking indicates a representative length Lᵣ of the fastener.

In one aspect, a fastener is provided. The fastener includes, but is not limited to, a head having an outer surface, a shank connected with the head at a first end and extending to a second end opposed to the first end, and an identification marking formed on the outer surface. The outer surface remains exposed upon the fastener being inserted into an object. The shank has an actual length Lₐ from the first end to the second end and a width W. The identification marking indicates a physical property of the fastener.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a first perspective view of a first fastener having an identification marking formed on a head of the fastener, in accordance with one embodiment;

FIG. 2 depicts a second perspective view of the fastener shown in FIG. 1, in accordance with one embodiment;

FIG. 3 depicts a first perspective view of a second fastener having an identification marking formed on a head of the fastener, in accordance with one embodiment; and

FIG. 4 depicts a side cross-sectional view of the first fastener driven through a first object and embedded within a second object, in accordance with one embodiment.

### DETAILED DESCRIPTION

Methods and devices consistent with the present invention overcome the disadvantages of conventional fasteners by using a fastener which has an identification marking on an outer surface of the fastener's head. The identification marking preferably indicates a physical property of the fastener. By viewing the identification marking on the outer surface of the fastener's head, which is visible even after installation of the fastener, interested parties may now determine the actual length or the embedment depth of a power driven fastener after installation without having to remove the fastener, and possibly causing damage to the first object, the second object, or the fastener itself.

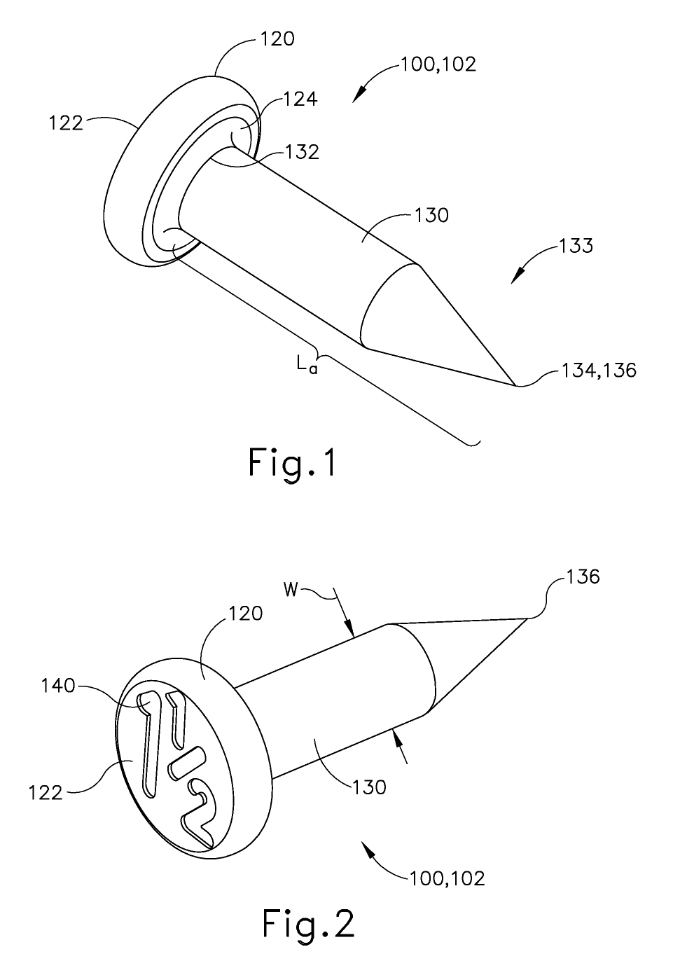

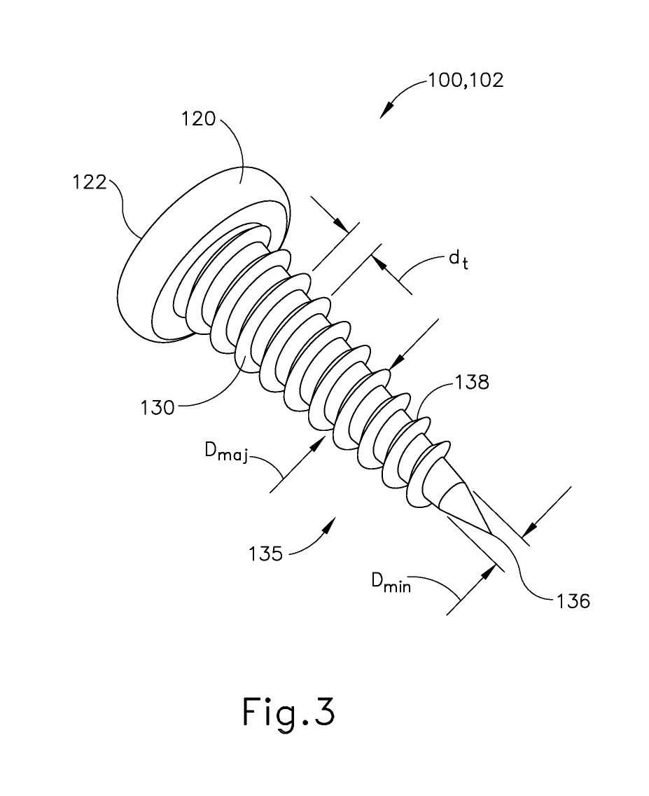

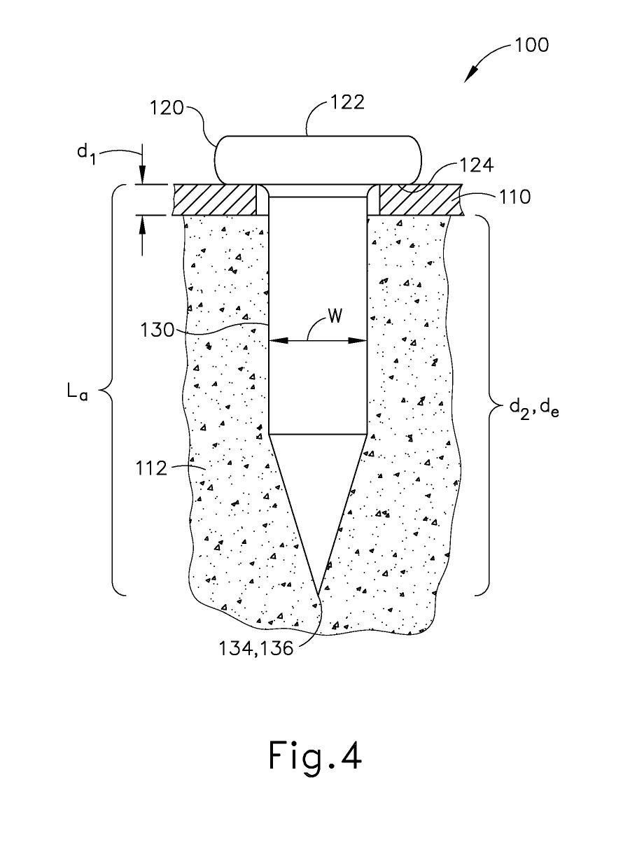

With reference to FIGS. 1, 2 and 4, there is shown one embodiment of a fastener 100 having an identification marking 140 formed on a head 120 of the fastener 100. Fastener 100 is any device which can be inserted into or through a first object 110 and then inserted into or through a second object 112, in order to secure or fasten the first object 110 to the second object 112, as shown in FIG. 4. Fastener 100 is a hardware device that mechanically joins or affixes two or more objects 110, 112 together. Fastener 100 can also be used to close a container such as a bag, a box, or an envelope; or fastener 100 may involve keeping together the sides of an opening of flexible material, attaching a lid to a container, etc. Examples of fastener 100 include a nail 133 as shown in FIG. 1, a screw 135 as shown in FIG. 3, a masonry anchor, a peg, a pin, a rivet, a tack, a threaded fastener, or a captive threaded fastener. Preferably, the fastener 100 has a one-piece structure a screw or a nail, and not a two-piece structure, such as a masonry anchor.

With reference to FIG. 3, in one embodiment the fastener 100 is a screw 135 having threads 138 having peaks and valleys on the shank 130, with a distance dₜ between peaks of threads 138 on the shank 130. In this embodiment, the shank 130 includes a major diameter Dₘₐⱼ along the peaks of threads 138 on the shank 130, and a minor diameter Dₘᵢₙ along the valleys of threads 138 on the shank 130.

Fastener 100 may be a manually inserted fastener 104, as shown in FIG. 3, which uses only human power to insert the manually inserted fastener 104 into or through the first or second object 110, 112 using a non-powered tool or hand tool, such as a screw driver or a conventional hammer. In one embodiment, with reference to FIGS. 1, 2 and 4, fastener 100 is a power driven fastener 102 which uses non-human power to drive the fastener 102 into or through the first or second object 110, 112 using a power tool. A power tool is a tool which is powered by an electric motor, an internal combustion engine, a steam engine, compressed air, direct burning of fuels and propellants, or even natural power sources like wind or moving water. In one embodiment, a power tool employing an explosive charge is used to drive the power driven fastener 102 into or through the first or second object 110, 112.

First or second objects 110, 112 are any objects into which a fastener 100 can be inserted into and are preferably objects used in construction to construct a building or home, such as a concrete slab, a piece of wood, a piece of metal, a bracket, a stud, a shelf, a floor, a wall, carpet, flooring, glass, stone, rubber, plastic, and drywall.

The fastener 100 includes the head 120 having an outer surface 122 opposed to an inner surface 124, a shank 130 connected with the head 120, and the identification marking 140 formed on the head 120. The head 120 is the portion of the fastener 100 through which a force is typically applied in order to insert the shank 130 of the fastener 100 into or through first or second objects 110, 112. Preferably, the outer surface 122 of the head 120 remains exposed upon the fastener 100 being inserted into or through first or second objects 110, 112, while the inner surface 124 and the shank 130 are typically hidden with the first or second objects 110, 112.

The shank 130 is connected with the inner surface 124 of the head 120 at a first end 132 of the shank 130 and has a second end 134 opposed to the first end 132. The shank 130 has an actual length Lₐ linearly measured from the first end 132 to the second end 134. Preferably, the actual length Lₐ of the shank 130 is equal to or greater than the sum of the first depth d₁ and the second depth d₂. Preferably, the shank 130 forms a tip 136 at the second end 134 to allow to easier insertion of the shank 130 into the first or second objects 110, 112.

With reference to FIG. 4, fastener 100 is inserted into or through a first object 110 a first depth d₁ and then inserted into or through a second object 112 a second depth d₂, in order to secure or fasten the first object 110 to the second object 112, as shown in FIG. 4. Preferably, the combination of the first depth d₁ and the second depth d₂ is approximately is approximately equal to, within ±10%, the actual length Lₐ of the shank 130 of the fastener 100.

With reference to FIG. 2, identification marking 140 is formed, and preferably, displayed on the outer surface 122 of the head 120. The identification marking 140 indicates a physical property of the fastener 100. The physical property includes any type of physical feature of the fastener 100 or any type of information about the fastener 100, excluding information pertaining to whom the manufacturer of the fastener 100 is, includes such things as a representative length Lᵣ of the fastener 100, the actual length Lₐ of the shank 130, the width W of the shank 130, a material which the fastener 130 is comprised of, a major diameter Dₘₐⱼ of the shank 130, a minor diameter Dₘᵢₙ of the shank 130, a distance dₜ between threads 138 on the shank 130, a hardness of the fastener 100, a manufacturing date of the fastener 100, a factory in which the fastener 100 was manufactured, and a unique identifier which identifies the fastener 100.

In one embodiment, the identification marking 140 indicates a representative length Lᵣ of the fastener 100. The representative length Lᵣ of the fastener 100 is any length of measurement which represents a length of the fastener 100 or an embedment depth into a first or second object 110, 112 for the fastener 110, and includes things such as the actual length Lₐ of the shank 130, the entire length L_{f} of the fastener 100 from the outer surface 122 to the tip 136, or an embedment depth dₑ of the fastener 100. In one embodiment, the identification marking 140 indicates an embedment depth dₑ of the fastener 100. The embedment depth dₑ of the fastener 100 is the depth d₂ which the fastener 100 is embedded into the second object 112. Preferably, the embedment depth dₑ is approximately equal to, within ±10%, the actual length Lₐ minus the first depth d₁. Preferably, the embedment depth dₑ is approximately equal to, within ±10%, the second depth d₂. In one embodiment, the representative length Lᵣ of the fastener 100 is within ±20% the actual length Lₐ of the shank 130.

Preferably, the identification marking 140 is stamped into the outer surface 122, however, the identification marking 140 may also be displayed on the outer surface 122 in any one of a number of ways, including being printed onto the outer surface 122 or engraved into the outer surface 122. By having an identification marking 140 on the outer surface 122 of the head 120, interested parties are allowed to determine the actual length Lₐ or the embedment depth dₑ of a fastener 100 after installation without having to remove the fastener 100, and possibly causing damage to the first object 110, the second object 112, or the fastener 100 itself.

In use, the fastener 100 is inserted, preferably with a power tool, through the first object 110, and preferably, into or through the second object 112, by an installer. Upon insertion, the installer, an interested third party such as a contractor or a building inspector, then views the identification marking 140 on the outer surface 122 of the head 120, which is visible even after installation of the fastener 100 in first object 110, and preferably, second object 120, and then determines the actual length or the embedment depth of a power driven fastener after installation without having to remove the fastener 100.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A fastener for being inserted a first depth d₁ through a first object and a second depth d₂ into or through a second object, comprising:
a head having an outer surface opposed to an inner surface, wherein the outer surface remains exposed upon the fastener being inserted into an object;
a shank connected with the inner surface of the head at a first end and forming a tip at a second end opposed to the first end, wherein the shank has an actual length Lₐ from the first end to the second end, and wherein the actual length Lₐ is equal to or greater than the sum of the first depth d₁ and the second depth d₂; and
an identification marking formed on the outer surface, wherein the identification marking indicates an embedment depth dₑ of the fastener.

2. The fastener of claim 1, wherein the identification marking indicates an embedment depth dₑ which is approximately equal to, within ±10%, the actual length Lₐ minus the first depth d₁.

3. The fastener of claim 1, wherein the fastener is a power driven fastener for installation with a power tool.

4. The fastener of claim 1, wherein the fastener is one of a screw or a nail.

5. The fastener of claim 1, wherein the identification marking is stamped into the outer surface.

6. A fastener comprising:
a head having an outer surface, wherein the outer surface remains exposed upon the fastener being inserted into an object;
a shank connected with the head at a first end and forming a tip at a second end opposed to the first end, wherein the shank has an actual length Lₐ from the first end to the second end; and
an identification marking formed on the outer surface, wherein the identification marking indicates a representative length Lᵣ of the fastener.

7. The fastener of claim 6, wherein the representative length Lᵣ of the fastener is an embedment depth dₑ of the fastener.

8. The fastener of claim 7, wherein the fastener is for being inserted a first depth d₁ through a first object and a second depth d₂ into or through a second object, and wherein the identification marking indicates an embedment depth dₑ which is approximately equal to, within ±10%, the actual length Lₐ minus the first depth d₁.

9. The fastener of claim 6, wherein the representative length Lᵣ of the fastener is within ±20% the actual length Lₐ of the shank.

10. The fastener of claim 6, wherein the fastener is a power driven fastener for installation with a power tool.

11. The fastener of claim 6, wherein the fastener is one of a screw or a nail.

12. The fastener of claim 6, wherein the identification marking is stamped into the outer surface.

13. A fastener comprising:
a head having an outer surface, wherein the outer surface remains exposed upon the fastener being inserted into an object;
a shank connected with the head at a first end and extending to a second end opposed to the first end, wherein the shank has an actual length Lₐ from the first end to the second end and a width W; and
an identification marking formed on the outer surface, wherein the identification marking indicates a physical property of the fastener.

14. The fastener of claim 13, wherein the physical property is either a representative length Lᵣ of the fastener, the actual length Lₐ of the shank, the width W of the shank, a material which the fastener is comprised of, a major diameter Dₘₐⱼ of the shank, a minor diameter Dₘᵢₙ of the shank, a distance dₜ between threads on the shank, a hardness of the fastener, a manufacturing date of the fastener, a factory in which the fastener was manufactured, and a unique identifier which identifies the fastener.

15. The fastener of claim 13, wherein the identification marking indicates a representative length Lᵣ of the fastener.

16. The fastener of claim 15, wherein the representative length Lᵣ of the fastener is an embedment depth dₑ of the fastener.

17. The fastener of claim 16, wherein the fastener is for being inserted a first depth d₁ through a first object and a second depth d₂ into or through a second object, and wherein the identification marking indicates an embedment depth dₑ which is approximately equal to, within ±10%, the actual length Lₐ minus the first depth d₁.

18. The fastener of claim 15, wherein the representative length Lᵣ of the fastener is within ±20% the actual length Lₐ of the shank.

19. The fastener of claim 13, wherein the fastener is a power driven fastener for installation with a power tool.

20. The fastener of claim 13, wherein the fastener is one of a screw or a nail.
